(19) United States
(12) Patent Application Publication
(10) Pub. No.: US 2026/0176940 A1
(43) Pub. Date: Jun. 25, 2026

(54) SYSTEMS AND METHODS FOR CONTROLLING GAS LIFT INJECTION RATES IN WELLS

(71) Applicant: Chevron U.S.A. Inc., San Ramon, CA (US)

(72) Inventors: Yula Tang, Richmond, TX (US); Yuanbo Lin, Midland, TX (US); Lanre Olabinjo, Midland, TX (US); Johannes Cornelis Visser, Katy, TX (US); Jose Luis Mejia Arellano, Midland, TX (US); Zachary Dana, Midland, TX (US); Divino Kipungo, Midland, TX (US); Patrick James Frain, Midland, TX (US)

(21) Appl. No.: 19/000,427

(22) Filed: Dec. 23, 2024

(51) Int. Cl. E21B 43/12; G05B 13/02

(52) U.S. Cl. CPC E21B 43/122; G05B 13/0265; E21B 2200/20

(57) ABSTRACT

Correspondence between gas lift injection rates and production rates for a well is determined, and correspondence between gas lift injection rates and net incremental values for the well is determined. The correspondence between gas lift injection rates and production rates for the well defines a gas lift performance curve for the well, and the correspondence between gas lift injection rates and net incremental values for the well defines a net incremental value curve for the well. Control of the gas lift injection rate for the well is facilitated based on the correspondence between gas lift injection rates and the net incremental values for the well.

### FIELD

The present disclosure relates generally to the field of increasing production efficiency from wells by controlling gas lift injection rates.

### BACKGROUND

Gas lift is used to enlighten the wellbore liquid column or the hydraulic head to lift the fluids to the surface when the reservoir pressure drops to a certain extent. Different gas lift injection rates may result in different amounts of production from the well. Controlling the gas lift injection rate in a well to maximize production from the well may result in inefficient production from the well.

### SUMMARY

This disclosure relates to controlling gas lift injection rates in wells. Well information and/or other information for a well may be obtained. The well information for the well may define values of time-dependent characteristics and values of time-independent characteristics for the well. Correspondence between values of gas lift injection rate and values of production rate for the well for a period of time may be determined based on the well information and/or other information. The correspondence between the values of the gas lift injection rate and the values of the production rate for the well may define a gas lift performance curve for the well. Correspondence between the values of the gas lift injection rate and values of net incremental value for the well for the period of time may be determined based on the well information and/or other information. The correspondence between the values of the gas lift injection rate and the values of the net incremental value for the well may define a net incremental value curve for the well. Control of the gas lift injection rate for the well may be facilitated based on the correspondence between the values of the gas lift injection rate and the values of the net incremental value for the well and/or other information.

A system for controlling gas lift injection rates in wells may include one or more electronic storage, one or more processors and/or other components. The electronic storage may store information relating to wells, well information, information relating to time-dependent characteristics for wells, information relating to time-independent characteristics for wells, information relating to correspondence between gas lift injection rates and production rates, information relating to gas lift performance curves, information relating to correspondence between gas lift injection rates and net incremental values, information relating to net incremental value curves, information relating to control of gas lift injection rates, and/or other information.

The processor(s) may be configured by machine-readable instructions. Executing the machine-readable instructions may cause the processor(s) to facilitate controlling gas lift injection rates in wells. The machine-readable instructions may include one or more computer program components. The computer program components may include one or more of a well component, a production rate component, a net incremental value component, a control component, and/or other computer program components.

The well component may be configured to obtain well information and/or other information for a well. The well information for the well may define values of time-dependent characteristics and values of time-independent characteristics for the well.

In some implementations, the time-dependent characteristics for the well may include flow path, productivity index, shut-in bottom hole pressure, gas-oil ratio, water cut, operating expenditure, capital expenditure, fluid price, and/or other time-dependent characteristics. In some implementations, the time-independent characteristics for the well may include well location, well geometry, production formation, downhole equipment, fixed costs, and/or other time-independent characteristics for the well.

The production rate component may be configured to determine correspondence between values of gas lift injection rate and values of production rate for the well for a period of time. The correspondence between values of gas lift injection rate and values of production rate for the well for the period of time may be determined based on the well information and/or other information. The correspondence between values of gas lift injection rate and values of production rate for the well may define a gas lift performance curve for the well.

In some implementations, the values of the gas lift injection rate and the values of the production rate for the period of time may be determined using one or more physics-based modeling for the well.

In some implementations, the correspondence between values of gas lift injection rate and values of production rate for the well may be determined for multiple production scenarios. Different ones of the multiple production scenarios may have different well locations, different production formations, and/or different times of production. One or more constraints may be applied to the multiple production scenarios.

The net incremental value component may be configured to determine correspondence between values of gas lift injection rate and values of net incremental value for the well for the period of time. The correspondence between values of gas lift injection rate and values of net incremental value for the well for the period of time may be determined based on the well information and/or other information. The correspondence between values of gas lift injection rate and values of net incremental value for the well may define a net incremental value curve for the well. In some implementations, the net incremental value curve may define the net incremental value for the well as a function of the gas lift injection rate.

The control component may be configured to facilitate control of the gas lift injection rate for the well. Control of the gas lift injection rate for the well may be facilitated based on the correspondence between the values of the gas lift injection rate and the values of the net incremental value for the well and/or other information. In some implementations, the control of the gas lift injection rate for the well includes setting the gas lift injection rate for the well to values with positive net incremental values for the well.

In some implementations, one or more machine learning models may be trained based on the values of gas lift injection rate with positive net incremental values for the well and/or other information. The machine learning model(s) may be trained to receive as input values of time-dependent characteristics and values of time-independent characteristics for a given well and trained to provide as output values of gas lift injection rate for the given well with positive net incremental value for the given well.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for controlling gas lift injection rates in wells.

FIG. 2 illustrates an example method for controlling gas lift injection rates in wells.

FIG. 3 illustrates an example gas lift performance curve.

FIG. 4 illustrates an example net incremental value curve.

FIG. 5 illustrates an example flow diagram for controlling gas lift injection rates in wells.

FIG. 6 illustrates an example flow diagram for controlling gas lift injection rates in wells.

### DETAILED DESCRIPTION

The present disclosure relates to controlling gas lift injection rates in wells. Correspondence between gas lift injection rates and production rates for a well is determined, and correspondence between gas lift injection rates and net incremental values for the well is determined. The correspondence between gas lift injection rates and production rates for the well defines a gas lift performance curve for the well, and the correspondence between gas lift injection rates and net incremental values for the well defines a net incremental value curve for the well. Control of the gas lift injection rate for the well is facilitated based on the correspondence between gas lift injection rates and the net incremental values for the well.

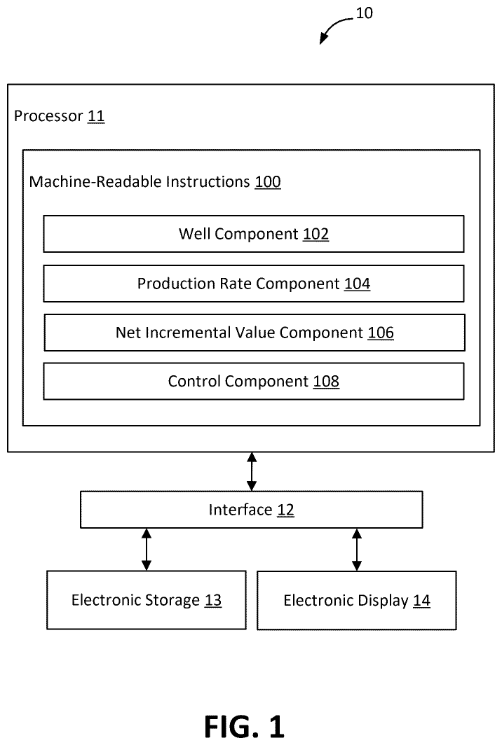

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Well information and/or other information for a well may be obtained by the processor 11. The well information for the well may define values of time-dependent characteristics and values of time-independent characteristics for the well. Correspondence between values of gas lift injection rate and values of production rate for the well for a period of time may be determined by the processor 11 based on the well information and/or other information. The correspondence between the values of the gas lift injection rate and the values of the production rate for the well may define a gas lift performance curve for the well. Correspondence between the values of the gas lift injection rate and values of net incremental value for the well for the period of time may be determined by the processor 11 based on the well information and/or other information. The correspondence between the values of the gas lift injection rate and the values of the net incremental value for the well may define a net incremental value curve for the well. Control of the gas lift injection rate for the well may be facilitated by the processor 11 based on the correspondence between the values of the gas lift injection rate and the values of the net incremental value for the well and/or other information.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store information relating to wells, well information, information relating to time-dependent characteristics for wells, information relating to time-independent characteristics for wells, information relating to correspondence between gas lift injection rates and production rates, information relating to gas lift performance curves, information relating to correspondence between gas lift injection rates and net incremental values, information relating to net incremental value curves, information relating to control of gas lift injection rates, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to wells, well information, information relating to time-dependent characteristics for wells, information relating to time-independent characteristics for wells, information relating to correspondence between gas lift injection rates and production rates, information relating to gas lift performance curves, information relating to correspondence between gas lift injection rates and net incremental values, information relating to net incremental value curves, information relating to control of gas lift injection rates, and/or other information.

Information may be provided (e.g., transmitted, made available for access/download) to one or more computing devices not shown in FIG. 1. For example, information relating to wells, well information, information relating to time-dependent characteristics for wells, information relating to time-independent characteristics for wells, information relating to correspondence between gas lift injection rates and production rates, information relating to gas lift performance curves, information relating to correspondence between gas lift injection rates and net incremental values, information relating to net incremental value curves, information relating to control of gas lift injection rates, and/or other information may be provided to one or more computing devices (e.g., IoT devices) to actuate the control of well equipment (e.g., change gas lift injection rate setpoint).

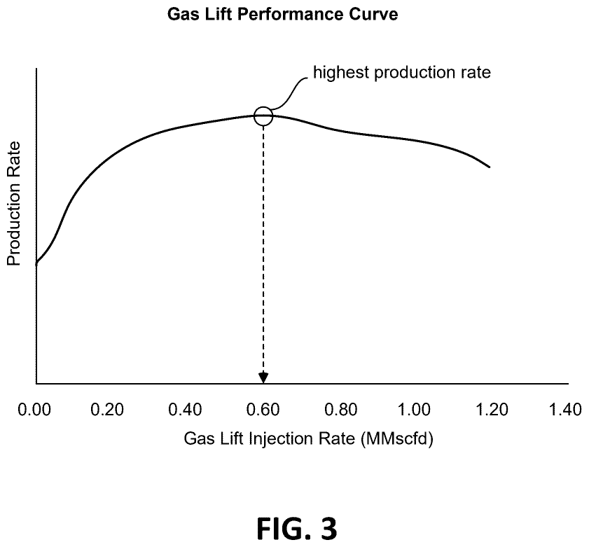

Gas lift may be applied to a well (wellbore) to indirectly promote production from a reservoir (unconventional reservoir) by lowering the bottomhole pressure. The gas lift injection rate may dominate the production effectiveness of the well. FIG. 3 illustrates an example gas lift performance curve. The gas lift performance curve may define production rate (liquid rate) as a function of gas lift injection rate for a moment in time (a given timestamp). The gas lift performance curve may map correspondence between values of gas lift injection rate and values of production rate. The highest point on the gas lift performance curve may correspond to the highest production rate for the well and the value of the gas lift injection rate (e.g., 0.6 MMscfd) that will result in the highest production rate from the well. However, controlling the gas lift injection rate of the well to obtain the highest production rate from the well may not result in efficient use of the well. For example, increasing gas lift injection rate may come with costs, and the additional costs of operating a well to increase production may be higher than the benefit of additional production from the well.

The present disclosure provides a tool to control the gas lift injection rate in a well. The amount of gas lift injection rate in the well is controlled (set, changed) to increase the efficiency of the well. Rather than targeting increased/maximum production from the well, the tool targets increased/maximum value (e.g., economic return value) from the well. The tool utilizes correspondence between values of gas lift injection rate and values of net incremental value for the well to control the gas lift injection rate in the well. The correspondence between values of gas lift injection rate and values of net incremental value for the well may change with time. The present disclosure may be used to control other operation parameters of a well. Descriptions relating to gas lift injection rate may be applied to other types of operation parameters of a well (e.g., gas lift injection pressure, submersible pump design, electrical submersible pump frequency, facility design, facility parameters).

The net incremental values for the well may refer to the amounts of additional value obtained from different amounts of gas lift injection rate in the well. The net incremental value may refer to the net economic value from changes in the gas lift injection rate in the well. The net incremental value may refer to the net economic value from incremental change in the gas lift injection rate in the well. For example, the net incremental value for the well may show the amount of total economic return provided by increasing the gas lift injection rate in the well (e.g., the gross economic value from well operation minus the cost of well operation from increasing gas lift by a certain amount).

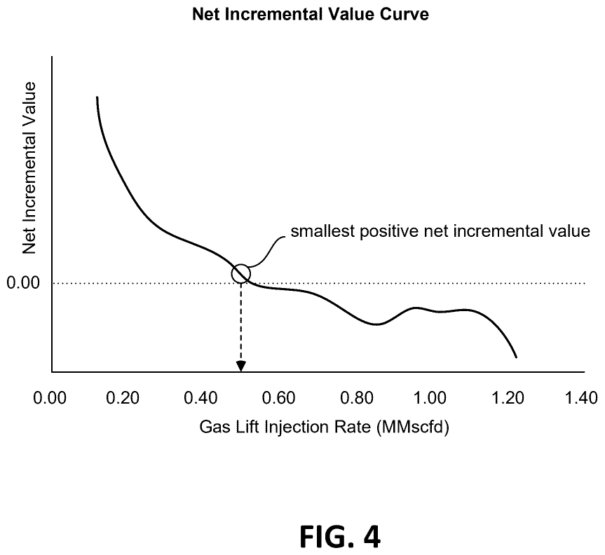

FIG. 4 illustrates an example net incremental value curve. The net incremental value curve may define net incremental value as a function of gas lift injection rate. The net incremental value curve may map correspondence between values of gas lift injection rate and values of net incremental value for the well. The point along the net incremental value curve with the smallest positive net incremental value may correspond to the gas lift injection rate at which positive return is obtained from well operation. In FIG. 4, the gas lift injection rate for a well may be changed in increments of 0.10 MMscfd. Other incremental changes in gas lift injection rate are contemplated.

For example, in FIG. 4, operating the well with 0.5 MMscfd gas lift injection rate may result in positive net incremental value. The economic return from using 0.5 MMscfd gas lift injection rate in the well may be greater than the cost from using 0.5 MMscfd gas lift injection rate in the well. Addition of 0.1 MMscfd from 0.4 MMscfd to 0.5 MMscfd may bring net positive increase because the cost associated with the additional 0.1 MMscfd is lower than the additional revenue from the production uplift. On the other hand, operating the well with 0.6 MMscfd gas lift injection rate may result in negative net incremental value. That is, the additional 0.1 MMscfd from 0.5 MMscfd to 0.6 MMscfd may not bring net positive increase because the cost associated with the additional 0.1 MMscfd is higher than the additional revenue from the production uplift. The economic return from increasing from 0.5 MMscfd to 0.6 MMscfd gas lift injection rate in the well may be more than offset by the cost from increasing from 0.5 MMscfd to 0.6 MMscfd gas lift injection rate in the well. Thus, additional net value may not be obtained by using 0.6 MMscfd gas lift injection rate in the well. The economic return from using gas lift injection rate higher than 0.5 MMscfd may be less than the cost from using higher gas lift injection rate in the well. To maximize return on the operation of the well, 0.5 MMscfd gas lift injection rate may be used.

Use of gas lift injection rate higher than 0.5 MMscfd may reduce the net value obtained from operating the well. Any increase in the economic return from using gas lift injection rate higher than 0.5 MMscfd may be lower than the overall costs of using the higher gas life injection rate. That is, after 0.5 MMscfd, positive economic value of increasing the gas lift injection rate may not offset the negative economic value from the costs of the higher gas lift injection rate.

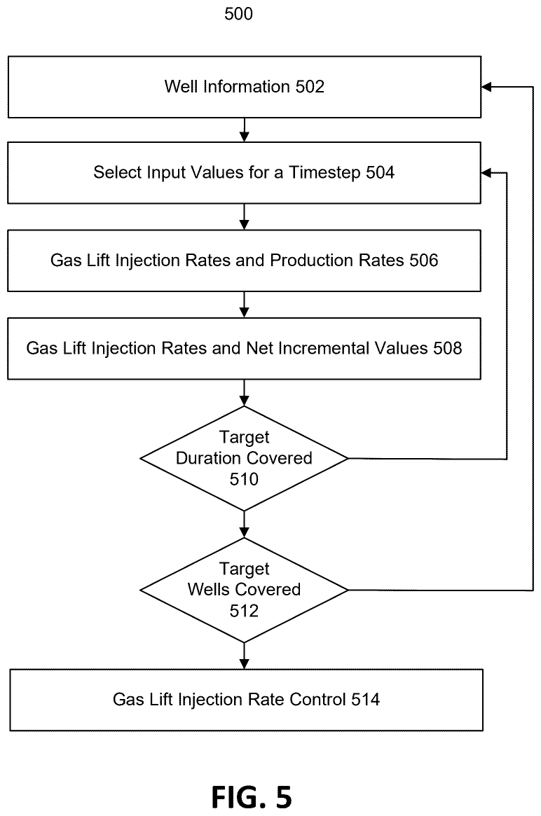

FIG. 5 illustrates an example flow diagram 500 for controlling gas lift injection rates in wells. Well information 502 for a well may be obtained. The well information 502 for the well may define values of time-dependent characteristics (time-dependent variables) and values of time-independent characteristics (time-independent variables) for the well. The values of time-dependent characteristics may be stored/described with one or more probabilistic distribution functions. The values of time-dependent characteristics may be stored/described in a tabular form and/or other forms for sampling. In some implementations, the values of time-dependent characteristics and the values of time-independent characteristics may be separately obtained and combined into a data set.

For example, time-dependent characteristics may include flow path, productivity index, shut-in bottom hole pressure, gas/oil ratio, water cut, operating expenditures, sales price, capital expenditures, and/or other non-fixed fees and/or non-fixed costs. The values of time-dependent characteristics for a period of time (e.g., future values of time-dependent characteristics) and/or distribution of the values at any given time may be described with one or more functions or within one or more tables. Time-dependent characteristics may further include time/age of the well (duration of time that well has been in operation). Time-independent characteristics may include well location, wellbore geometry, production formation, downhole equipment (e.g., types of downhole equipment (e.g., valve, tubing), configuration of downhole equipment, such as gas lift value settings), and/or other fixed fees and/or fixed costs. Other time-dependent characteristics and other time-independent characteristics are contemplated.

Two different sets of values may be combined into a data set for the well. The data set may have multiple dimensions: time dimensions with different timestamps within the well's lifespan; distribution dimension (probabilistic distribution of the variables at a given timestamp). The data set may be stored in a tabular form (e.g., different two-dimensional tables that define correlations between parameters for different timestamps; a three-dimensional table that defines correlations between parameters with time being a dimension of the table; table(s) with additional dimensions for well characteristics, such as production formation, probabilistic distribution, etc.).

Input values for a timestep of the well may be selected 504. A set of input variable values for a sampled timestamp of the well's life may be selected. The set of input variable values may refer to an input sample containing a combination of time-dependent variables and time-independent variables at a given timestamp. The selection may be randomly performed, subject to one or more constraints. For example, Monte Carlo sampling may be performed with one or more constraints to limit the selection to realistic values (e.g., physically realistic variables).

For example, a set of input variables may be randomly selected for a sampled timestamp of the well's life. The random selection may be performed to ensure sufficient/complete coverage/reflection of individual input variable's probabilistic statistical distribution. The selected input variables may be checked against one or more constraints. The check may be performed to ensure that the randomly selected combination of input variables comply with physics/makes physical sense. If the selected input variables conflict with the constraints, they may be dropped. If the selected input variables satisfy the constraints, they may be retained for use in modeling well operations. The selection of input variables may be repeated until a sufficient number of samples are obtained for the timestamp. For a given time in the life of the well, random selection and check against constraints may be performed until enough samples of input variables have been retained to represent the probabilistic statistical distributions of the input variables.

For the sampled timestamp of the well's life, values of gas lift injection rate and corresponding values of production rate may be determined 506. The values of gas lift injection rate and corresponding values of production rate may be determined based on the randomly selected combinations of input variables (combinations that have been retained for modeling after satisfying the constraints), inflow performance relationship for a well, and/or other information. The inflow performance relationship may provide information on flow characteristics at the well. The inflow performance relationship may define the relationship between oil production and the pressure at the bottom of the well. Modeling may be performed using the randomly selected combinations of input variables for the stamped timestamp. Different combinations of input variables may define different production scenarios for modeling. A specific combination of time-dependent variables and time-independent variables may define a specific production scenario for modeling.

For example, a combination of time-dependent variables and time-independent variables may be selected for use in modeling operation of a well. The well may have a range of possible gas lift injection rates, and a value of gas lift injection rate may be selected as an input. The selected combination of time-dependent variables and time-independent variables, along with the selected value of gas lift injection rate may be used to determine the value of production rate at the well. For example, the selected combination of time-dependent variables and time-independent variables may be run through a physics-based model (e.g., multi-phase flow modeling) at the selected gas lift injection rate to determine the production rate at the well. This may establish correspondence between a single value of gas lift injection rate and a single value of production rate for the sampled timestamp in a production scenario. This process may be repeated for different values of gas lift injection rate until the range of possible gas lift injection rate has been covered. The correspondence between different gas lift injection rates and production rates may define a gas lift performance curve for the well. In some implementations, one or more gas lift performance curves for the well may be generated. A gas lift performance curve may indicate production rates for different gas lift injection rates at a given point in time for a production scenario.

For the sampled timestamp of the well's life, values of gas lift injection rate and corresponding values of net incremental value may be determined 508. An economic-based model may be used to determine the economic value and/or the economic cost of operating the well at the selected gas lift injection rate. The economic cost of operating the well at the selected gas lift injection rate may be deducted from the economic value of operating the well at the selected gas lift injection rate to determine the corresponding net incremental value of operating the well at the selected gas lift injection rate. This may establish correspondence between a single value of gas lift injection rate and a single value of net incremental value for the sampled timestamp in the production scenario. This process may be repeated for different values of gas lift injection rate until the range of possible gas lift injection rate has been covered. The correspondence between different gas lift injection rates and net incremental values may define a net incremental value curve for the well. In some implementations, one or more net incremental value curves for the well may be generated. A net incremental value curve may indicate net incremental values for different gas lift injection rates at a given point in time for a production scenario.

Whether a target duration has been covered may be determined 510 based on the timestamps of the well's life covered by the steps 504, 506, 508. The target duration may refer to a duration/period of time over which modeling is to be performed (e.g., one or more hours, one or more days, one or more weeks, one or more months, one or more years, one or more decades). In some implementations, the target duration may include the life of the well (entire life of the well, remaining life of the well). If the target duration has not been covered by the modeling, the process may return to step 504 for selection of another sampled timestamp for modeling. The next timestamp may be a set duration (one or more hours, one or more days, one or more weeks, one or more months, one or more years, one or more decades) from the current timestamp.

If the target duration has been covered, the process may continue to determine whether the target wells have been covered 512. The target wells may refer to the number/types of wells for which modeling is to be performed. The target wells may refer to wells in a given area of interest. The target wells may refer to wells with different subsurface configurations (e.g., different well location, different well geometry, different production formation, different downhole equipment configuration). If the target wells have not been covered by the modeling, the process may return to selection of different well information/different well for modeling. If the target wells have been covered by the modeling, the process may continue to control 514 the gas lift injection rate for one or more wells using the correspondence between the gas lift injection rates and the net incremental values established through the modeling.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate controlling gas lift injection rates in wells. The machine-readable instructions 100 may include one or more computer program components. The machine-readable instructions 100 may include one or more of a well component 102, a production rate component 104, a net incremental value component 106, a control component 108, and/or other computer program components.

The well component 102 may be configured to obtain well information and/or other information for one or more wells. Obtaining well information may include one or more of accessing, acquiring, analyzing, determining, developing, examining, generating, identifying, loading, locating, measuring, opening, preparing, receiving, retrieving, reviewing, selecting, storing, and/or otherwise obtaining the well information. Well information for a single well or multiple wells may be obtained. The well component 102 may obtain well information from one or more locations. For example, the well component 102 may obtain well information from a storage location, such as the electronic storage 13, electronic storage of a device accessible via a network, and/or other locations. The well component 102 may obtain well information from one or more hardware components (e.g., a computing device, a sensor) and/or one or more software components (e.g., software running on a computing device). The well component 102 may obtain well information from one or more users (e.g., entry of well information by a user).

The well information for a well may define values of time-dependent characteristics and values of time-independent characteristics for the well. A well may refer to a hole that is drilled in the ground. A well may be drilled in the ground for exploration and/or recovery of resources in the ground, such as water or hydrocarbons. For example, a well may be drilled for production of hydrocarbons (e.g., as a production well). The term “wellbore,” “well bore,” “borehole,” and the like may be utilized interchangeably with the term “well.” A well may be located in a reservoir.

A reservoir may refer to a location at which one or more resources are stored. For example, a reservoir may refer to a location at which hydrocarbons are stored. For instance, a reservoir may refer to a location including rocks in which oil and/or natural gas have accumulated. A reservoir may include one or more wells. For example, a reservoir may include one or more injection wells (e.g., for injection of fluid), one or more production wells (e.g., for extraction of oil or gas), and/or other wells. A reservoir may refer to a location in which buoyant forces keep hydrocarbons in place below a sealing caprock. A reservoir may refer to a location in which oil or natural gas do not readily flow into a well. A reservoir may refer to a location in which hydraulic fractures may be used to extract the stored resources, such as an unconventional reservoir (e.g., tight-sand, gas and/or oil shales). An unconventional reservoir may refer to a reservoir where hydrocarbons and/or other resources (e.g., oil, gas) are tightly bound to the rock fabric by strong capillary forces. Resources may be held by dense structure with lower permeability.

In some implementations, a well may include a gas lift well. A gas lift well may be located in an unconventional reservoir. Use of the present disclosure on other types of wells in conventional reservoirs or unconventional reservoirs is contemplated.

A characteristic for a well may refer to an attribute, quality, configuration, parameter, and/or characteristics of matter inside, within, and/or around the well. A characteristic for a well may refer to characteristics of the well, characteristics of one or more components of the well, characteristics of conditions around the well (e.g., the reservoir in which the well is located), characteristics of conditions inside the well, characteristics of equipment for the well (e.g., equipment installed at the well, equipment installed at the reservoir), and/or other characteristics of matter that impacts operation of the well.

Time-independent characteristics for a well may refer to characteristics for a well that do not change with time. Time-independent characteristics for a well may refer to characteristics for a well that are not expected to change with time. Time-independent characteristics for a well may refer to characteristics for a well that that do not/are not expected to change more than a threshold amount with time. For example, time-independent characteristics for a well may include well location (e.g., geospatial location, geographic coordinate such as longitude and latitude of the well, depth of the well), well geometry (e.g., area, shape, profile), production formation (e.g., materials surrounding the well, such as different rock types), downhole equipment, fixed costs (e.g., of operating the well, local taxes), and/or other time-independent characteristics for the well.

Time-dependent characteristics for a well may refer to characteristics for a well that changes with time. Time-dependent characteristics for a well may refer to characteristics for a well that are expected to change with time. Time-dependent characteristics for a well may refer to characteristics for a well that that change/are expected to change more than a threshold amount with time. For example, time-dependent characteristics for a well may include productivity index, shut-in bottom hole pressure, gas-oil ratio, water cut, expenditure (e.g., operating expenditure and capital expenditure, such as for rental/maintenance of equipment, water disposal costs, transportation costs), fluid price (e.g., oil price, gas price), and/or other time-dependent characteristics. The uncertainties of the values of the time-dependent characteristics may be characterized by one or more statistical ranges (e.g., P10, P50, P90). The uncertainties of the values of the time-dependent characteristics may be characterized by one or more statistical distributions.

In some implementations, a characteristic may change from being time-independent to time-dependent, and/or vice versa. For example, well geometry and/or downhole equipment may change due to a workover operation. Well geometry and/or downhole equipment may be treated as time-dependent characteristics rather than time-independent characteristics. Characteristics that change infrequently (e.g., at a lower frequency than threshold frequency) may be treated as semi-time-dependent characteristics.

The well information may define values of characteristics for a well by including information that characterizes, describes, delineates, identifies, is associated with, quantifies, reflects, sets forth, and/or otherwise defines the values of the characteristics for the well. The well information may directly and/or indirectly define values of characteristics for a well. For example, the well information may define values of characteristics for a well by including information that specifies the types and/or the values of the characteristics for the well and/or information that may be used to determine the types and/or values of the characteristics for the well. The well information may define values of time-dependent characteristics as a function of time. The well information may define values of time-dependent characteristics at different moments in time. The well information may define values of time-dependent characteristics over one or more durations of time. Other types of well information are contemplated.

The production rate component 104 may be configured to determine correspondence between values of gas lift injection rate and values of production rate for the well(s) for one or more periods of time. Determining correspondence between values of gas lift injection rate and values of production rate may include ascertaining, approximating, calculating, establishing, estimating, finding, identifying, obtaining, selecting, setting, and/or otherwise determining the correspondence between values of gas lift injection rate and values of production rate. Different gas lift injection rates may be mapped to different production rates.

The correspondence between values of gas lift injection rate and values of production rate may be determined for one or more periods of time (e.g., one or more hours, one or more days, one or more weeks, one or more months, one or more years, one or more decades). The correspondence between values of gas lift injection rate and values of production rate for a well may be determined for one or more parts of the life of the well. The correspondence between values of gas lift injection rate and values of production rate for a well may be determined for the life of the well.

The correspondence between values of gas lift injection rate and values of production rate for a well for a period of time may be determined based on the well information and/or other information. The correspondence between values of gas lift injection rate and values of production rate may be determined based on values of time-dependent characteristics and/or values of time-independent characteristics for the well. Separate correspondence between values of gas lift injection rate and values of production rate may be determined for different times. Separate correspondence between values of gas lift injection rate and values of production rate may be determined for separate production scenarios. A production scenario may be defined by a specific combination of time-dependent variables (values of time-dependent characteristics) and time-independent variables (values of time-independent characteristics).

The correspondence between values of gas lift injection rate and values of production rate for a well may define a gas lift performance curve for the well. The gas lift performance curve may define production rate of the well as a function of gas lift injection rate. In some implementations, one or more gas lift performance curves for a well may be generated. The gas lift performance curve(s) may be presented on one or more displays.

In some implementations, values of gas lift injection rate and values of production rate for a period of time may be determined using one or more physics-based modeling for a well. Values of production rate that correspond to different values of gas lift injection rate may be determined using the physic-based modeling for the well. A physics-based modeling may include modeling of the well and the reservoir in which the well is located. A physics-based modeling may include modeling of equipment installed at the well/reservoir. A physics-based modeling may simulate production rates for different gas lift injection rates using time-dependent variables and/or time-independent variables for the well.

The correspondence between values of gas lift injection rate and values of production rate may be determined for multiple production scenarios. In some implementations, different production scenarios may have different well locations, different production formations, and/or different times of production. Different times of production may include same or different constraints on production. For example, different times of production may include same or different constraints on production due to facility processing capacity, product takeaway capacity, water disposal capacity, and/or other capacities for production. The correspondence between values of gas lift injection rate and values of production rate may be determined through time for different production scenarios.

One or more constraints may be applied to production scenarios. A constraint may refer to a limitation or a restriction on what qualifies as a production scenario. The constraints may be applied to the production scenarios to remove production scenarios that are not realistic. The constraints may be applied to the production scenarios to remove production scenarios that do not make physical sense. The constraints may be applied to the production scenarios to remove production scenarios that do not match the wells/reservoir to be modeled. For example, Monte Carlo sampling may select values for a production scenario that does not make physical sense. Such a production scenario may be removed from use. Correspondence between values of gas lift injection rate and values of production rate may not be determined for production scenarios that do not satisfy the constraint(s). Correspondence between values of gas lift injection rate and values of production rate may be determined for production scenarios that satisfy the constraint(s).

The net incremental value component 106 may be configured to determine correspondence between values of gas lift injection rate and values of net incremental value for the well(s) for one or more periods of time. Determining correspondence between values of gas lift injection rate and values of net incremental value may include ascertaining, approximating, calculating, establishing, estimating, finding, identifying, obtaining, selecting, setting, and/or otherwise determining the correspondence between values of gas lift injection rate and values of net incremental value. Different gas lift injection rates may be mapped to different net incremental values.

The correspondence between values of gas lift injection rate and values of net incremental value may be determined for one or more periods of time (e.g., one or more hours, one or more days, one or more weeks, one or more months, one or more years, one or more decades). The correspondence between values of gas lift injection rate and values of net incremental value for a well may be determined for one or more parts of the life of the well. The correspondence between values of gas lift injection rate and values of net incremental value for a well may be determined for the life of the well.

The correspondence between values of gas lift injection rate and values of net incremental value for the well for a period of time may be determined based on the well information and/or other information. The correspondence between values of gas lift injection rate and values of net incremental value may be determined based on values of time-dependent characteristics and/or values of time-independent characteristics for the well. Separate correspondence between values of gas lift injection rate and values of net incremental value may be determined for different times. Separate correspondence between values of gas lift injection rate and values of net incremental value may be determined for separate production scenarios.

The correspondence between values of gas lift injection rate and values of net incremental value for a well may define a net incremental value curve for the well. The net incremental value curve may define the net incremental value for the well as a function of the gas lift injection rate. In some implementations, one or more net incremental value curves for a well may be generated. The net incremental value curve(s) may be presented on one or more displays.

In some implementations, values of gas lift injection rate and values of net incremental value for a period of time may be determined using one or more economics-based modeling for a well. Values of net incremental value that correspond to different values of gas lift injection rate may be determined using the economics-based modeling for the well. An economics-based modeling may take as input production rates for different gas lift injection rates (output from physics-based modeling), and determine the difference between the total revenue generated from the production (e.g., sale of oil, sale of gas) and the total costs of the production. An economics-based modeling may simulate net incremental values for different gas lift injection rates using time-dependent variables and/or time-independent variables for the well.

The correspondence between values of gas lift injection rate and values of net incremental value may be determined for multiple production scenarios. The correspondence between values of gas lift injection rate and values of net incremental value may be determined through time for different production scenarios. The correspondence between values of gas lift injection rate and values of net incremental value may be determined for multiple production scenarios as a function of time. Production scenarios may be varied and time within the production scenarios may be varied in determining the correspondence between values of gas lift injection rate and values of net incremental value.

The control component 108 may be configured to facilitate control of the gas lift injection rate for the well(s). Facilitating control of the gas lift injection rate for a well may include assisting, automating, carrying out, controlling, designing, enabling, implementing, initiating, performing, planning, scheduling, setting up, and/or otherwise facilitating the control of the gas lift injection rate for the well. Facilitating control of the gas lift injection rate for a well may include automatically starting, stopping, changing, preventing, and/or otherwise controlling the gas lift injection rate for the well. For example, operations at the well may be automated by utilizing actuators and/or controllers to change the amount of gas lift injection rate for the well. Facilitating control of the gas lift injection rate for a well may include providing information about the gas lift injection rate for the well to one or more personnels (e.g., engineers, field operators). For example, information on the gas lift injection rate to increase/maximize return from operating the well and/or other information relating to the gas lift injection rate may be presented on one or more displays. Facilitating operation of a well may include recommending the gas lift injection rate for the well to one or more personnels. Other facilitations of control of gas lift injection rate for the well(s) are contemplated.

Control of the gas lift injection rate for the well may be facilitated based on the correspondence between the values of the gas lift injection rate and the values of the net incremental value for the well and/or other information. Control of the gas lift injection rate for a well may be facilitated based on the net incremental value curve(s) for the well.

In some implementations, the control of the gas lift injection rate for a well may include setting the gas lift injection rate for the well to values with positive net incremental values for the well. In some implementations, the control of the gas lift injection rate for a well may include setting the gas lift injection rate for the well to values with zero net incremental values for the well. The gas lift injection rate may be changeable via increments, and the gas lift injection rate may be set to the last value with positive/zero net incremental value before the values with negative net incremental value. Rather than setting the gas lift injection rate for a well to the value that will maximize production from the well, the gas lift injection rate may be set to the value that will maximize economic return from the well. For example, referring to FIG. 4, the gas lift injection rate for a well may be changed in increments of 0.10 MMscfd. Gas lift injection rate of 0.50 MMscfd may correspond to positive net incremental value while gas lift injection rate of 0.60 MMscfd may correspond to negative net incremental value. Gas lift injection rate greater than 0.50 may correspond to negative net incremental values. Gas lift injection rate of 0.50 MMscfd may be the last/highest value with positive net incremental value. Gas lift injection rate of 0.50 MMscfd may correspond to the smallest positive net incremental value. To increase/maximize economic return from the well, the gas lift injection rate for the well may be set to 0.50 MMscfd. The gas lift injection rate to increase/maximize economic return may be determined for one or more moments in time and/or for one or more durations of time. The gas lift injection rate to increase/maximize economic return may be forecasted for future operation of the well.

In some implementations, one or more machine learning models may be trained based on the values of gas lift injection rate with positive net incremental values for the well and/or other information. The machine learning models may be trained based on the values of gas lift injection rate with the smallest positive net incremental value. The machine learning models may be trained based on the last/highest values of gas lift injection rate with positive net incremental value.

The machine learning model(s) may be trained to receive as input values of time-dependent characteristics and values of time-independent characteristics for a well. The machine learning model(s) may be trained to receive as input information that defines production scenarios for the well. The machine learning model(s) may be trained to provide as output values of gas lift injection rate for the well with positive net incremental value for the given well. The machine learning model(s) may be trained to provide as output values of gas lift injection rate with the smallest positive net incremental value. The machine learning model(s) may be trained to provide as output the last/highest values of gas lift injection rate with positive net incremental value. Use of the gas lift injection rate output by the machine learning model(s) for a given production scenario may increase/maximize economic return from the well. The machine learning model(s) may be used as a proxy of the process described herein to determine gas lift injection rate to increase/maximize economic return from the well. Use of other modeling approaches (e.g., curve fitting) is contemplated.

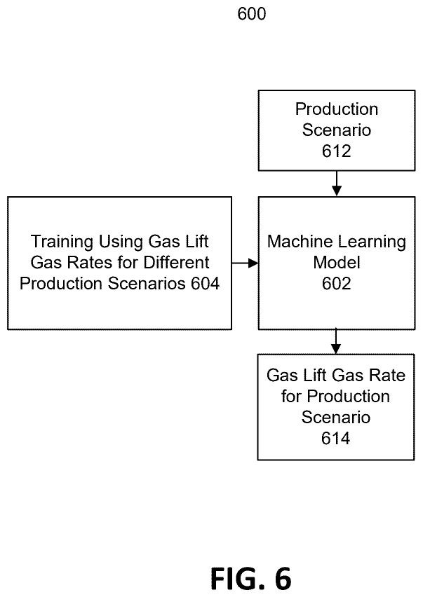

FIG. 6 illustrates an example flow diagram 600 for controlling gas lift injection rates in wells. A machine learning model 602 may be trained 604 using gas lift injection rate for different production scenarios. Production scenarios may be defined by time-dependent characteristics and time-independent characteristics for well. Production scenarios may be defined by age of the well. Gas lift injection rates for different production scenarios may include gas lift injection rates that increase/maximize economic return from the well for the different production scenarios. Different production scenarios may be paired with gas lift injection rates that increase/maximize economic return from the well for the different production scenarios to train 604 the machine learning model 602. For example, the machine learning model 602 may be trained using values of time-dependent characteristics and time-independent characteristics that define different production scenarios, along with values of gas lift injection rates that maximize economic return from the well for the different production scenarios.

Responsive to a production scenario 612 being input to the machine learning model 602, the machine learning model 602 may output gas lift injection rate that will increase/maximize economic return for the production scenario 612. For example, values of time-dependent characteristics and time-independent characteristics that define the production scenario 612 may be input to the machine learning model 602, and the machine learning model 602 may output the values of gas lift injection rate over time that will maximize economic return from the well for the production scenario 612. The machine learning model 602 may be used to determine the gas life injection rates to be used now and/or in the future.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

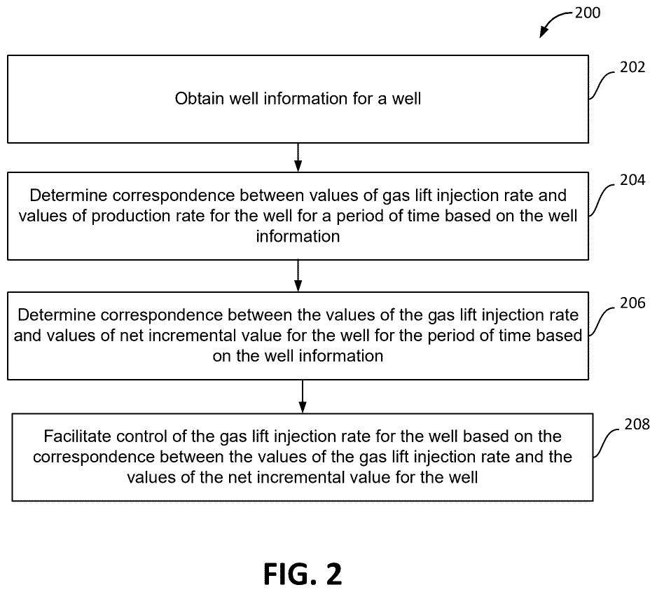

FIG. 2 illustrates a method 200 for controlling gas lift injection rates in wells. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, well information for a well may be obtained. The well information for the well may define values of time-dependent characteristics and values of time-independent characteristics for the well. In some implementations, operation 202 may be performed by a processor component the same as or similar to the well component 102 (Shown in FIG. 1 and described herein).

At operation 204, correspondence between values of gas lift injection rate and values of production rate for the well for a period of time may be determined based on the well information. The correspondence between the values of the gas lift injection rate and the values of the production rate for the well may define a gas lift performance curve for the well. In some implementations, operation 204 may be performed by a processor component the same as or similar to the production rate component 104 (Shown in FIG. 1 and described herein).

At operation 206, correspondence between the values of the gas lift injection rate and values of net incremental value for the well for the period of time may be determined based on the well information. The correspondence between the values of the gas lift injection rate and the values of the net incremental value for the well may define a net incremental value curve for the well. In some implementations, operation 206 may be performed by a processor component the same as or similar to the net incremental value component 106 (Shown in FIG. 1 and described herein).

At operation 208, control of the gas lift injection rate for the well may be facilitated based on the correspondence between the values of the gas lift injection rate and the values of the net incremental value for the well. In some implementations, operation 208 may be performed by a processor component the same as or similar to the control component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for controlling gas lift injection in wells, the system comprising:
one or more physical processors configured by machine-readable instructions to:
obtain well information for a well, the well information for the well defining values of time-dependent characteristics and values of time-independent characteristics for the well;
determine correspondence between values of gas lift injection rate and values of production rate for the well for a period of time based on the well information, the correspondence between the values of the gas lift injection rate and the values of the production rate for the well defining a gas lift performance curve for the well;
determine correspondence between the values of the gas lift injection rate and values of net incremental value for the well for the period of time based on the well information, the correspondence between the values of the gas lift injection rate and the values of the net incremental value for the well defining a net incremental value curve for the well; and
facilitate control of the gas lift injection rate for the well based on the correspondence between the values of the gas lift injection rate and the values of the net incremental value for the well.

2. The system of claim 1, wherein the correspondence between the values of the gas lift injection rate and the values of the production rate for the well is determined for multiple production scenarios.

3. The system of claim 2, wherein different ones of the multiple production scenarios have different well locations, different production formations, and/or different times of production.

4. The system of claim 3, wherein one or more constraints are applied to the multiple production scenarios.

5. The system of claim 1, wherein the net incremental value curve defines the net incremental value for the well as a function of the gas lift injection rate.

6. The system of claim 1, wherein the values of the gas lift injection rate and the values of the production rate for the period of time are determined using a physics-based modeling for the well.

7. The system of claim 1, wherein the time-dependent characteristics for the well include flow path, productivity index, shut-in bottom hole pressure, gas-oil ratio, water cut, operating expenditure, capital expenditure, and/or fluid price.

8. The system of claim 1, wherein the time-independent characteristics for the well include well location, well geometry, production formation, downhole equipment, and/or fixed costs.

9. The system of claim 1, wherein the control of the gas lift injection rate for the well includes the gas lift injection rate for the well being set to values with positive net incremental values for the well.

10. The system of claim 9, wherein a machine learning model is trained based on the values of the gas lift injection rate with positive net incremental values for the well, the machine learning model trained to receive as input values of the time-dependent characteristics and values of the time-independent characteristics for a given well and trained to provide as output values of the gas lift injection rate for the given well with positive net incremental value for the given well.

11. A method for controlling gas lift injection in wells, the method comprising:
obtaining well information for a well, the well information for the well defining values of time-dependent characteristics and values of time-independent characteristics for the well;
determining correspondence between values of gas lift injection rate and values of production rate for the well for a period of time based on the well information, the correspondence between the values of the gas lift injection rate and the values of the production rate for the well defining a gas lift performance curve for the well;
determining correspondence between the values of the gas lift injection rate and values of net incremental value for the well for the period of time based on the well information, the correspondence between the values of the gas lift injection rate and the values of the net incremental value for the well defining a net incremental value curve for the well; and
facilitating control of the gas lift injection rate for the well based on the correspondence between the values of the gas lift injection rate and the values of the net incremental value for the well.

12. The method of claim 11, wherein the correspondence between the values of the gas lift injection rate and the values of the production rate for the well is determined for multiple production scenarios.

13. The method of claim 12, wherein different ones of the multiple production scenarios have different well locations, different production formations, and/or different times of production.

14. The method of claim 13, wherein one or more constraints are applied to the multiple production scenarios.

15. The method of claim 11, wherein the net incremental value curve defines the net incremental value for the well as a function of the gas lift injection rate.

16. The method of claim 11, wherein the values of the gas lift injection rate and the values of the production rate for the period of time are determined using a physics-based modeling for the well.

17. The method of claim 11, wherein the time-dependent characteristics for the well include flow path, productivity index, shut-in bottom hole pressure, gas-oil ratio, water cut, operating expenditure, capital expenditure, and/or fluid price.

18. The method of claim 11, wherein the time-independent characteristics for the well include well location, well geometry, production formation, downhole equipment, and/or fixed costs.

19. The method of claim 11, wherein controlling the gas lift injection rate for the well includes setting the gas lift injection rate for the well to values with positive net incremental values for the well.

20. The method of claim 19, wherein a machine learning model is trained based on the values of the gas lift injection rate with positive net incremental values for the well, the machine learning model trained to receive as input values of the time-dependent characteristics and values of the time-independent characteristics for a given well and trained to provide as output values of the gas lift injection rate for the given well with positive net incremental value for the given well.
